(19) United States
(12) Patent Application Publication
(10) Pub. No.: US 2012/0048120 A1
(43) Pub. Date: Mar. 1, 2012

(54) Clark's Pre-Tamp

(76) Inventor: Clark Wayne Gillaspie, Boca Grande, FL (US)

(21) Appl. No.: 12/806,910

(22) Filed: Aug. 25, 2010

(51) Int. Cl. A47J 31/44

(52) U.S. Cl. 99/287

(57) ABSTRACT

Clark's Pre-Tamp is a device incorporating a disk with tines to stir espresso ground coffee in an espresso portafilter basket to create a more even distribution of the grounds after dosing and prior to tamping in order to improve the taste of the resulting extraction of espresso coffee. Further improvement of taste is achieved when the disk with tines is moved both horizontally and vertically simultaneously. Yet further improvement is realized when a helix or worm gear is used, allowing the horizontal motion to continue, without stopping or reversing, as the disk with tines is moved vertically down into the ground coffee in the basket and then back up and out of the basket. Clark's Pre-Tamp can be manually or electrically operated, and it can be used alone, or attached to or incorporated into other devices used in the preparation of espresso coffee.

### CROSS-REFERENCE TO RELATED APPLICATIONS

Provisional patent application No. 61/274,635

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

In general terms, there are three major steps for the barista in preparing an excellent shot of espresso.

The first major step is acquiring freshly roasted coffee beans of superior quality, suitable for espresso extraction. The beans can be single origin or a blend, they can be lightly roasted or dark roasted, they can be acidic, bright, earthy, with notes of dark chocolate, caramel, dried figs, or spice, rich, full-bodied, subtle, smoky, with long-lasting after taste, rich aroma, copper crema, etc. etc. From this wonderful menu of possibilities, the barista must select those beans that have the characteristics best suited to his intended audience, whether it be himself, his customers, or the judges in a competition.

The second major step is the creation of a compacted puck of ground coffee in the filter basket, ready for the extraction process. This step includes four aspects: grinding, dosing, distribution and tamping (i.e. compression of the grounds in the basket). Proper grinding, dosing, distribution and tamping are necessary to produce excellent espresso that embodies all the best the beans have to offer.

The third major step is the extraction process itself. Temperature and pressure must be carefully controlled so that the desired volume of espresso is created in the appropriate interval of time. Subtleties such as the chemistry of the water and pre-infusion also come into play.

There is disagreement concerning the relative importance of each aspect of this complicated, delicate and artful process, but most will agree that every step is important to some degree. Most will also agree that failure to execute any step properly can prevent the successful creation of excellent espresso.

The subject invention, Clark's Pre-Tamp, is a device for creating an even distribution of the ground coffee in the filter basket, after grinding and dosing, and prior to tamping. Even distribution means having a consistent density of coffee throughout the basket. Espresso extraction is accomplished with near-boiling water at a pressure of about 8 to 10 bars (about three times the pressure found in the water pipes of the average home). The goal is to expose all areas of the puck to the same volume of near-boiling water for the same amount of time in order to cause an even extraction of all of the best flavors contained in the high quality, freshly ground beans chosen by the barista. If the compacted puck of ground coffee does not have consistent density, the near-boiling water under pressure will shoot through any weak or less dense areas of the puck, and that is called channeling. Channeling causes bitterness and weak taste.

Channeling occurs when a disproportionately large volume of the brew water flows through only a portion of the puck (i.e. the near-boiling water under pressure finds a path of lesser resistance). The grounds in the area of the channeling are over-extracted, and that results in bitter tastes being carried into the cup. If some of the grounds are exposed to a disproportionately large volume of brew water, then other areas of the puck must be exposed to a disproportionately small volume of water (i.e. some of the ground coffee is under-extracted). Under-extraction means that some of the rich and complex flavors that should be in the cup remain behind, trapped in the under-extracted grounds in the puck, resulting in a weak extraction. Channeling causes bitterness and weakness in the espresso in the cup.

Channeling is such a serious issue that some baristas try to monitor the effectiveness of their techniques in eliminating channeling by cutting out the bottoms of their portafilters in order to observe the espresso as it leaves the filter basket. Channeling causes the stream of espresso flowing from the basket to have a less than ideal form, color and consistency.

Channeling does not occur if the puck has consistent density.

Properly ground for espresso, the coffee is very fine, very light and fluffy, and somewhat clingy; even the slightest touch can compact the coffee (i.e. create localized higher density) at and near the point of contact. Due to these characteristics of the ground coffee, achieving an even distribution in the filter basket has not been an easy task.

Clark's Pre-Tamp is a simple and easy way to consistently create an even distribution of ground coffee in the filter basket, after proper grinding and dosing, and before tamping.

2. Description of the Prior Art

The role of the barista starts with the selection of appropriate, freshly-roasted coffee beans.

The barista converts the whole beans into a puck of compacted, ground coffee in the filter basket, ready for the extraction process. There are four aspects of creating the puck: grinding, dosing, distribution, and tamping.

Three of these aspects, grinding, dosing and tamping, are generally well managed and under control. The fourth aspect, distribution, is not.

Grinders of various designs, and various costs, can grind the beans to the precise, granularity and consistency the barista requires.

Dosing is achieved by using the grinder's doser (a volumetric measurement), by sweeping the top of the basket (another volumetric measurement), or by using a scale (a weight measurement).

Tamping (compression of the grounds in the basket) can be done by hand with tampers of various designs (flat or convex, short-handled or long-handled, stainless steel or aluminum, heavy or light weight, etc.) or with a mechanical device created for this purpose.

But the fourth aspect of this process, ensuring even distribution of the ground coffee in the filter basket prior to tamping, has been addressed only indirectly.

Generally speaking, good baristas try to combine grinding, dosing and distribution. They use top quality grinders with doser attachments. The best grinders are able to grind coffee uniformly and with little clumping. Many good baristas tend to use the grinder's doser, not as a measuring device, but more as a sifter. Moving the portafilter around while repeatedly thwacking the doser lever as the ground coffee falls down the grinder's chute will layer the coffee into the filter basket. When the basket is full the barista will sweep the top of the basket with a finger or fingers, with a part of the palm, or with a stick or knife, sometimes straight across, sometimes with twisting motions, sometimes once, sometimes more. At the end of this process he hopes to have the desired dose of properly ground coffee distributed evenly in the filter basket.

All such techniques, however, are indirect methods to achieve accurate dosing and even distribution. They require skill, practice and consistency, and they are not particularly effective in correcting for anything that may go wrong, such as any clumping caused by the grinder or any uneven layering of the grounds laid down by the thwacking of the doser. They also assume that a volumetric measurement (i.e. sweeping the top of the basket) is an accurate substitute for weighing the coffee. It may or may not be. And it may be more accurate under some circumstances and less accurate under others.

Even if the best baristas are able to achieve reasonably accurate dosing and reasonably even distribution on a reasonably consistent basis, that leaves all the other baristas, amateur and professional alike, struggling to achieve even distributions in order to minimize or eliminate channeling.

The blogs are filled with endless discussions on how to achieve good distributions and compacted pucks of even density. Baskets, sometimes only partially filled, are tapped or banged on the counter, deeper baskets are used, and various instruments are employed to break up clumps of ground coffee. Some employ special hand movements. Others try to compensate for uneven distribution with special tampers or special tamping techniques. Tampers are made of various materials, have different weights and lengths, and have flat or convex bottoms. Some use light tamping pressure, most use 30 pounds of pressure, more or less, and some believe more pressure is required. Some push straight down and others recommend rotating motions. Most recommend a single tamp, but others use more than one. In any event, no tamper, no amount of tamping, and no tamping technique can cause the puck to have consistent density if the ground coffee is not properly distributed in the filter basket prior to the tamping.

All of these problems and shortcomings would be eliminated if the distribution of the ground coffee in the filter basket were a positive, purposeful action, and not just an occasionally adequate consequence of other actions.

Clark's Pre-Tamp provides an even distribution for any dosage, whether or not the grounds are clumped. There is no need to own the most expensive grinders, no need to thwack the doser lever, no need to move the portafilter around under the doser, no need to sweep or twist, no need to tap or bang, no need to rely on volume as a reasonable way to measure weight, no need to use special tampers or employ special tamping techniques, and no need to cut out the bottom of your portafilter (unless you just like to watch). Clark's Pre-Tamp creates an even distribution of ground coffee in the filter basket, after grinding and dosing, and before tamping. After using Clark's Pre-Tamp, the subsequent tamping has a smooth and satisfying feel as the evenly distributed coffee grounds are compacted into a puck of even density, ready for the extraction of an excellent shot of espresso.

### BRIEF SUMMARY OF THE INVENTION

Clark's Pre-Tamp is a device incorporating a disk with tines to stir espresso ground coffee in an espresso portafilter basket to create a more even distribution of the grounds after dosing and prior to tamping in order to improve the taste of the resulting extraction of espresso coffee. Further improvement of taste is achieved when the disk with tines is moved both horizontally and vertically simultaneously. Yet further improvement is realized when a helix or worm gear is used, allowing the horizontal motion to continue, without stopping or reversing, as the disk with tines is moved vertically down into the ground coffee in the basket and then back up and out of the basket.

Clark's Pre-Tamp can be manually or electrically operated, and it can be used alone, or attached to or incorporated into other devices used in the preparation of espresso coffee.

As a stand alone device, the components can be contained conveniently in a hollow, bottomless, cylinder approximately 3″ in diameter and 6″ high that is placed over the portafilter basket.

In the model incorporating the helix or worm gear, the disk with tines is positioned above the basket before the stirring begins. The disk is then rotated through approximately ten revolutions, at about one revolution per second. Such revolutions could be caused manually by turning a handle, or electrically by activating a motor. During the first five or so revolutions the disk with tines moves downward approximately 1″ until the ends of the tines are reaching almost to the bottom of the basket. As the tines move horizontally and vertically down through the ground coffee, they break up any clumps and fill any voids. During the second five or so revolutions the disk with tines moves upward back to its starting position with the tines above the basket. As the tines move horizontally and vertically back up through the basket, they leave behind a bed of evenly distributed ground coffee ready for tamping and extraction.

### BRIEF DESCRIPTION OF THE SEVERAL VIEWS OF THE DRAWING

FIG. 1 is a vertical section of a manual prototype of the invention taken through the center.

FIG. 2 is a vertical section of an electrical motor driven prototype of the invention, taken through the center.

### DETAILED DESCRIPTION OF THE INVENTION

### 1. The Stirring Disk

The essential physical feature of the invention is a disk with tines used to stir the espresso ground coffee in the portafilter filter basket.

Coffee that is ground finely for espresso extraction is light and fluffy, is easily compacted by the slightest pressure, and is somewhat “sticky” in the sense that moving a particular bit of ground coffee in the filter basket results in movement of adjacent and nearby bits of ground coffee. These properties make handling the ground coffee and creating an even distribution in the filter basket quite difficult. Imprecise handling or manipulation of the ground coffee can create areas or higher or lower density. The importance of an even distribution is discussed in the section entitled Background of the Invention.

Trial and error has shown that it is very easy to create uneven distributions and very difficult to create uniform distributions. Due to the nature of the ground coffee as described above, it is very easy to agitate the ground coffee into areas of higher and lower density, and even to create pockets, with tines that are too fat, tines that are too close, tines that are angled the wrong way, tines that are moved too quickly, or tines that change direction. It is also easy to create areas of low density at the center of the filter basket and at its perimeter. The object is to gently stir the ground coffee into a condition of even density, and not to scrape or plow it into areas of higher and lower density.

The Stirring Disk and tines can be made of any preferred rigid material, and the tines can be attached in any convenient manner. In all the prototypes, the Stirring Disks were made of ¼″ thick acrylic plastic and the tines were 1″ sewing pins secured in place with epoxy. The sewing pins are very thin and very rigid, making them highly suitable for the application.

The best configuration of tines discovered to date through trial and error is as follows. The first tine is positioned ⅛″ from the center of the Stirring Disk. The next is ⅛″ further from the center of the Stirring Disk and 105 degrees trailing the previous one. (“Trailing” means “behind” the previous tine taking into consideration the direction of the rotational motion of the Stirring Disk.) And so on, until the last tine is one-half the inside diameter of the Filter Basket away from the center of the Stirring Disk, less ⅛″.

When placed as described above, the tines trace concentric circles ⅛″ apart. Closer spacing results in plowing motions, excess fluffing, and voids. Looser spacing results in insufficient stirring. The ⅛″ concentric spacing means that no portion of the ground coffee in the Filter Basket will have been greater than 1/16″ of horizontal distance from a tine with each complete revolution of the Stirring Disk. Due to the sticky nature of the espresso ground coffee, the influence of a tine passing through espresso ground coffee extends at least 1/16″ and therefore the ⅛″ concentric placement is sufficiently close to provide complete stirring of the ground coffee.

When the tines are attached to the Stirring Disk, they should be angled in two directions. First, each should be angled toward the outside so that the free end of the tine is ⅛″ closer to the perimeter of the Stirring Disk than is its point of attachment to the Stirring Disk. Second, each should be angled back away from the direction of travel of the Stirring Disk, so that the free end of the tine trails its point of attachment by ⅛″. These angles are necessary to reduce the tendency of a rotational stirring action to leave a void at the center of the filter basket and to leave areas of low density at the perimeter of the basket.

### 2. Motion of the Stirring Disk

The Stirring Disk is rotated so the tines can gently stir the ground coffee in the filter basket.

When rotated slower than the ideal rate, the process takes more time than necessary. When rotated faster than the ideal rate, the tines fluff the ground coffee creating voids and areas of lower density.

Trial and error has shown the ideal rate to be approximately one revolution per second, or sixty revolutions per minute. At that rate, the outermost tine is traveling through the ground coffee at about 3″ per second, which seems to be the greatest speed possible so as not to fluff and clump the ground coffee.

The earliest prototypes employed rotational motion only. Five or six rotations of the Stirring Disk seemed ideal. Fewer were not as effective; more were no more effective. The distribution of the ground coffee in the filter basket was more even than without use of the Stirring Disk and the taste of the espresso was improved, but only marginally.

An improved model incorporated simultaneous vertical and rotational movement of the Stirring Disk. The Stirring Disk was attached to the end of a threaded rod. Acme threads or similar are particularly suitable for this purpose as they rotate freely and typically have fewer threads per inch which speeds the vertical movement of the Stirring Disk, thereby reducing the number of revolutions required to complete the stirring action. The Stirring Disk was positioned above the filter basket and the threaded rod was turned causing the Stirring Disk to rotate and move downward. When the tines reached the bottom of the filter basket, the rotation of the threaded rod was reversed causing the Stirring Disk to rotate in the opposite direction and move back up to its starting position. This improved model created a more even distribution of the ground coffee in the filter basket and more improvement of taste. However, the change in direction of rotation of the Stirring Disk seemed to result in some areas of lower density, and therefore the results were somewhat inconsistent.

Replacing the threaded rod with a worm gear or helix grooves allowed the rotational motion of the Stirring Disk to continue in the same direction during both the downward and upward travel of the tines through the ground coffee. The results are consistent and very good.

The simultaneous horizontal and vertical movement is very effective. The downward rotational movement of the tines in the first half of the operation breaks up the clumps, fills the voids, and creates a fairly uniform distribution. The upward rotational movement of the second half of the operation, combined with the angular set of the tines, lays down, gently and evenly, tiny trails of ground coffee as the ends of the tines describe concentric helical paths up and out of the ground coffee, leaving behind a smooth, even distribution ready for tamping.

In the prototype the helix grooves of the worm gear are spaced so as to cause vertical movement of approximately 3/16″ per revolution. Given that the ideal horizontal spacing of the tines is ⅛″ (resulting in no part of the ground coffee being further than 1/16″ horizontally from a tine), the 3/16″ inch of vertical movement seems excessive. However, as adjacent tines are spaced slightly less than ⅓ of a circle apart, the helixes described by the ends of adjacent tines are spaced almost exactly ⅛″ apart, which means that, in three dimensions, every portion of the ground coffee comes within 1/16″ of the end of a tine as the Stirring Disk makes its climb back up and out of the ground coffee in the filter basket. As discussed above, the 1/16″ dimension is satisfactory given the “sticky” nature of the espresso ground coffee.

In all events, best results are obtained when the motion of the Stirring Disk is both uniform and smooth.

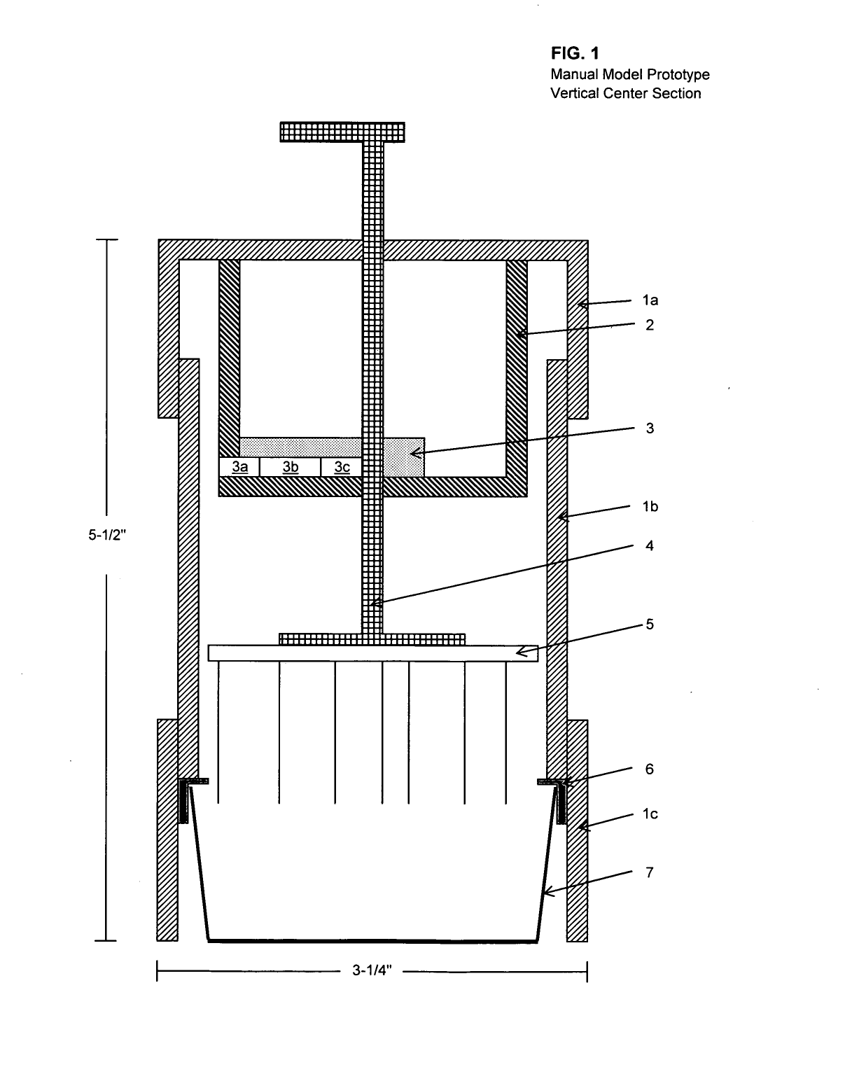

### 3. Brief Description of the Components of the Manual Prototype of FIG. 1

Case 1. The cylindrical Case 1 is approximately 3″ in diameter and approximately 6″ high, including all three of its component parts, the Case Top 1a, the Case Body 1b and the Case Bottom 1c. The Case 1 could be made of any desired, rigid material, such as plastic or metal or a combination thereof. The three component parts are held together mechanically, but ideally in such a manner as to allow easy disassembly for cleaning and interchanging parts. In the prototype, the three parts of the Case 1 were attached using small screws spaced 120 degrees apart. If desired, the Case 1 could consist on only two parts, or be a single piece enclosure. The prototype Case 1 was three components for aesthetics, for ease of construction, and for ease of disassembly and cleaning.

Internal Assembly Platform 2. The Internal Assembly Platform 2 holds the Pawl Assembly 3 and provides a bearing surface for the Worm Gear Assembly 4.

Pawl Assembly 3. The Pawl Assembly 3 includes a block attached to the inside of the Internal Assembly Platform 2 that encloses a Set Screw 3a that forces a Coil Spring 3b to gently push the Pawl 3c into the helix grooves of the Worm Gear Assembly 4.

Worm Gear Assembly 4. The Worm Gear Assembly 4 consists of three components: a cylindrical shaft with helix grooves on the lower portion, a handle at the top for manual turning of the Worm Gear Assembly 4, and a flange at the bottom to the Stirring Disk 5 is attached.

Stirring Disk 5. The Stirring Disk 5 has tines that move through the ground coffee in the Filter Basket 7 to create an even distribution of said coffee. During operation of the device, the Stirring Disk 5 rotates and moves vertically, simultaneously. The Stirring Disk 5 is attached to the flange of the Worm Gear Assembly 4 so that removal is relatively quick and easy for cleaning and interchangeability. In the prototype, this attachment is made with three small machine screws.

Shim 6. The Shim 6 is not a necessary component, but it is a relatively inexpensive way to make the device useable with a wide variety of sizes of filter baskets and portafilters simply by interchanging shims. The Shim 6 is a hoop to hold the Filter Basket 7 centered in the device. The Shim 6 also positions the Filter Basket 7 so that the tines of the Stirring Disk 5 come within 1/16″ to ⅛″ of the bottom of the Filter Basket 7 during operation of the device. A Shim 6 could be made of any convenient, rigid material, such as metal or plastic, and could be held in place by friction.

Filter Basket 7. The Filter Basket 7 is not a part of the device; it is shown for reference only.

### 4. Dimensions of the Manual Model of FIG. 1

The Case 1 of the prototype is approximately 3″ in diameter and approximately 6″ tall. Generally, in building the device, absolute dimensions are not critical, but relative dimensions are. The following are dimensional considerations that must be observed in construction of the device.

All of the sizing considerations begin with the Filter Basket 7. The diameter of the Case Bottom 1c must be equal to or greater than the Filter Basket 7, and the free depth of the Case Bottom 1c must be 1/16″ to ⅛″ less than the outside depth of the Filter Basket 7. The lesser depth is needed so that friction between the Case 1 and the Filter Basket 7 will keep the Filter Basket 7 from rotating inside the Case 1 while the stirring action is occurring. If the device will be used by baristas who desires to keep the Filter Basket 7 in the portafilter while dosing, distributing and tamping, then the Case Bottom 1c (and Shim 6 if used) would need to be sized to fit over the portafilter along with its ears.

If one desires to make the device usable with a variety of filter baskets of differing depths and diameters, then the Case Bottom 1c should be made to accommodate the widest and the deepest. If this is done, then an appropriately sized Shim 6 could be inserted to make the device work with any particular filter basket or portafilter.

The Filter Basket 7 also dictates the dimensional characteristics of the Stirring Disk 5. The tines must be equal to or greater than the depth of the Filter Basket 7, and the diameter of the Stirring Disk 5 must allow the outermost tine to describe a circle equal to the inside diameter of the bottom of the Filter Basket 7. In the prototype, the Stirring Disk 5 is attached to the flange at the bottom of the Worm Gear Assembly 4 using three ⅜″ 8×32 machine screws.

If the device is being built to accommodate various sizes of filter baskets and/or portafilters, then a “sizing kit” consisting of an appropriate shim and stirring disk would be needed.

The diameter of the Case Body 1b is dictated by the diameter of the Case Bottom 1c, and the diameter of the Case Top 1a is dictated by the diameter of the Case Body 1b.

The relative heights of the Case Body 1b and Case Top 1c are dictated by aesthetics. The combined absolute height of the Case Body 1b and Case Top 1c is dictated by the length of the tines on the Stirring Disk 5, by the total height of the helix grooves on the Worm Gear Assembly 4, and by the depth of the Filter Basket 7. When the Stirring Disk 5 is at the top of its vertical travel, the tines must be above the top rim of the Filter Basket 7. When the Stirring Disk 5 is at the bottom of its vertical travel, the bottom ends of the tines must be 1/16″ to ⅛″ above the bottom of the Filter Basket 7.

The outside diameter of the Internal Assembly Platform 2 must be less than the inside diameter of the Case Body 1b.

The height of the Internal Assembly Platform 2 is dictated by aesthetics and practicality. The height should be great enough so that the two bearing surfaces of the Worm Gear Assembly 4 (i.e. the Case Top 1a and the bottom of the Internal Assembly Platform 2) are far enough apart to provide lateral stability to the Worm Gear Assembly 4 during operation. Also, aesthetically, one would prefer that the helix grooves on the Worm Gear Assembly 4 not clear the Case Top 1a during operation. In the prototype, the Internal Assembly Platform 2 is approximately 2″ in diameter and approximately 2 high. The Internal Assembly Platform 2 must be “attached” to the Case Top 1a in some manner, and be easily detachable for maintenance and cleaning. In the prototype, this was accomplished by having the Internal Assembly Platform 2 thread into place on the underside of the Case Top 1a.

The vertical shaft of the Worm Gear Assembly 4 is round and smooth, with helix grooves cut into a portion of it near the bottom. The vertical height of the helix grooves needs to be sufficient for the tines of the Stirring Disk 5 to start above the Filter Basket 7 and to reach near the bottom of the Filter Basket 7 during operation. In the prototype, the vertical height of the helix grooves is 1½″ in order to accommodate 1½″ tines for triple filter baskets. The overall length of the vertical shaft needs to be sufficient so that the handle on the top of the shaft remains above the Case Top 1a when the Pawl 3c is riding in the uppermost helix groove (and the Worm Gear Assembly 4 is at the lowest point of its vertical motion).

For ease of assembly and disassembly, the entire shaft should have the same diameter.

The handle attached to the top of the upper shaft can be anything preferred by the user. In the prototype, the handle is ¼″ thick acrylic plastic with a ⅝″ hole; a finger is inserted into the hole to turn the handle to operate the device.

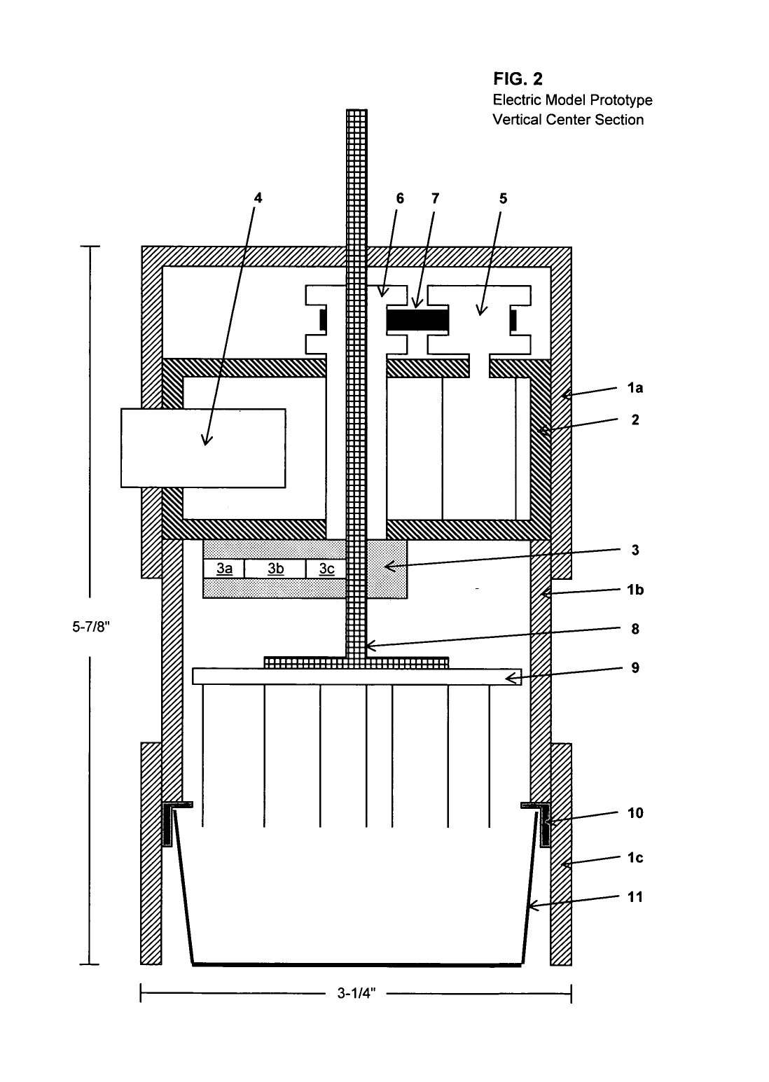

### 5. Brief Description of the Components of the Electrical Prototype of FIG. 2

Case 1. The cylindrical Case 1 is approximately 3″ in diameter and approximately 6″ high, including all three of its component parts, the Case Top 1a, the Case Body 1b and the Case Bottom 1c. The Case 1 could be made of any desired, rigid material, such as plastic or metal or a combination thereof. The three component parts are held together mechanically, but ideally in such a manner as to allow easy disassembly for cleaning and interchanging parts. In the prototype, the three parts of the Case 1 were attached using small screws spaced 120 degrees apart. If desired, the Case 1 could consist on only two parts, or be a single piece enclosure. The prototype Case 1 was three components for aesthetics, for ease of construction, and for ease of disassembly and cleaning.

Internal Assembly Platform 2. The Internal Assembly Platform 2 holds the Pawl Assembly 3, the Electronics 4 and the Motor 5, and it provides bearing surfaces for both the Idler 6 and the Worm Gear Assembly 8.

Pawl Assembly 3. The Pawl Assembly 3 includes a block attached to the bottom of the Internal Assembly Platform 2 that encloses a Set Screw 3a that forces a Coil Spring 3b to gently push the Pawl 3c into the helix grooves of the Worm Gear Assembly 8.

Electronics 4. The Electronics 4 package includes a power input jack, a momentary closed normally open button switch, and motor speed control circuitry if required. Electrical power is delivered to the device through the input jack. For safety and convenience, the power delivered should be low voltage (probably in the range of 5 to 12 volts DC), and low amperage (probably no greater than 1 amp), both as determined by the power requirements of the Motor 5.

Motor 5. The Motor 5 is mounted on the Internal Assembly Platform 2. Rotation of the motor causes rotation of the Idler 6. This may be accomplished in any convenient manner. The drawing depicts the pulleys and belt used in the prototype, but gears or rubber wheels could be employed.

Idler 6. The Idler 6 bears on the Internal Assembly Platform 2 and is rotated by the Motor 5. The Idler 6 must impart rotational motion to the Worm Gear Assembly 8 while simultaneously allowing the Worm Gear Assembly 8 to move vertically. In the prototype, this was accomplished through the use of a square shaft riding inside a square tube. The upper portion of the Idler 6 contains an imbedded, square tube. The top portion of the Worm Gear Assembly 8 is a square shaft that fits inside the square tube of the Idler 6. The size difference between the tube and shaft allows for relative longitudinal movement but not relative lateral movement. The result is that rotational movement is transferred from the Idler 6 to the Worm Gear Assembly 8 without interfering with the vertical movement of the Worm Gear Assembly 8 caused by the action of the Pawl 3c riding in the helix grooves of the Worm Gear Assembly 8 when the Worm Gear Assembly 8 is rotated.

Belt 7. In the prototype, the rotation of the Motor 5 was transmitted to the Idler 6 using pulleys and a Belt 7. As stated above, this transmission could be accomplished in any convenient manner, such as with gears or rubber wheels.

Worm Gear Assembly 8. The Worm Gear Assembly 8 consists of three components. The lowest is a flange to which the Stirring Disk 9 is attached. The middle component is the cylindrical worm gear shaft with the helix grooves in which the Pawl 3c rides. The upper portion is a square shaft as discussed above.

Stirring Disk 9. The Stirring Disk 9 has tines that move through the ground coffee in the Filter Basket 11 to create an even distribution of said coffee. During operation of the device, the Stirring Disk 9 rotates and moves vertically, simultaneously. The Stirring Disk 9 is attached to the flange on the Worm Gear Assembly 8 so that removal is relatively quick and easy for cleaning and interchangeability. In the prototype, this attachment is made with three small machine screws.

Shim 10. The Shim 10 is not a necessary component, but it is a relatively inexpensive way to make the invention useable with a wide variety of sizes of filter baskets and portafilters simply by interchanging shims. The Shim 10 is a hoop to hold the Filter Basket 11 centered in the device. The Shim also positions the Filter Basket 11 so that the tines of the Stirring Disk 9 come within 1/16″ to ⅛″ of the bottom of the Filter Basket 11 during operation of the device. A Shim 10 could be made of any convenient, rigid material, such as metal or plastic, and could be held in place by friction.

Filter Basket 11. The Filter Basket 11 is not a part of the device; it is shown for reference only.

### 6. Dimensions of the Electrical Model of FIG. 2

The Case 1 of the prototype is approximately 3″ in diameter and approximately 6″ tall. Generally, absolute dimensions are not critical, but relative dimensions are. The following are dimensional considerations that must be observed in construction of the device.

All of the sizing considerations begin with the Filter Basket 11. The diameter of the Case Bottom 1c must be equal to or greater than the Filter Basket 11, and the free depth of the Case Bottom 1c must be 1/16″ to ⅛″ less than the outside depth of the Filter Basket. The lesser depth is needed so that friction between the Case 1 and the Filter Basket 11 will keep the Filter Basket 11 from rotating inside the Case 1 while the stirring action is occurring. If the device will be used by baristas who desire to keep the Filter Basket 11 in the portafilter while dosing, distributing and tamping, then the Case Bottom 1c (and Shim 10 if used) would need to be sized to fit over the portafilter along with its ears.

If one desires to make the device usable with a variety of filter baskets (and/or portafilters) of differing depths and diameters, then the Case Bottom 1c should be made to accommodate the widest and the deepest. If this is done, then an appropriately sized Shim 10 could be inserted to make the device work with any particular filter basket or portafilter.

The Filter Basket also dictates the dimensional characteristics of the Stirring Disk 9. The tines must be equal to or greater than the depth of the Filter Basket 11, and the diameter of the Stirring Disk 9 must allow the outermost tine to describe a circle equal to the inside diameter of the Filter Basket 11. In the prototype, the Stirring Disk 9 is attached to the flange at the bottom of the Worm Gear Assembly 8 using three ⅜″ 8×32 machine screws.

If the device is being built to accommodate various sizes of filter baskets and/or portafilters, then a “sizing kit” consisting of an appropriate shim and stirring disk would be needed.

The diameter of the Case Body 1b is dictated by the diameter of the Case Bottom 1c. The diameter of the Case Top 1a is dictated by the diameter of the Case Body 1b.

The height of the Case Body 1b is dictated by the length of the tines on the Stirring Disk 9, by the total height of the helix grooves on the Worm Gear Assembly 8, and by the depth of the Filter Basket 11. When the Stirring Disk 9 is at the top of its vertical travel, the tines must be above the top rim of the Filter Basket 11. When the Stirring Disk 9 is at the bottom of its vertical travel, the bottom ends of the tines must be 1/16″ to ⅛″ above the bottom of the Filter Basket 11.

The height of the Case Top 1a is dictated by the height of the Internal Assembly Platform 2 and the free space above the platform occupied by the pulleys.

The diameter of the Internal Assembly Platform 2 is dictated by the diameter of the Case Top 1a. The height of the Internal Assembly Platform 2 is dictated by the size of the Motor 5 (and perhaps by the size of the Electronics 4 if they need additional space). In the prototype, the Motor is a hobby servo (HiTec HS-81) with a housing that is approximately 1″ tall. In the prototype, the Internal Assembly Platform 2 consists of two acrylic disks, ¼″ thick and approximately 2¾″ in diameter, held apart by ½″ diameter nylon posts, 1″ long, with 1½″ 6×32 machine screws passing through their centers. The three posts are more or less equally spaced at the perimeter of the acrylic disks.

The relative size of the pulleys or gears or wheels of the Motor 5 and the Idler 6 needs be such that the Idler 6 is driven by the Motor 5 at a speed of approximately one revolution per second. The pulleys or gears or wheels could be positioned above or below the upper disk of the Internal Assembly Platform 2. In the prototype, the pulleys were positioned above the upper disk for ease of mounting the Motor 5 and to minimize the total vertical dimension of the device.

The Internal Assembly Platform 2 must be “attached” to the Case Top 1a in some manner. In the prototype, acorn style locking nuts were placed on the three 6×32 machine screws above the upper platform disk, and those nuts index into notches cut into the Case Top 1a.

The length of the Idler 6 is dictated by the height of the Internal Assembly Platform 2 and the thickness of its pulley or wheel or gear. The diameter of the body of the Idler 6 must be at least sufficient to accommodate an imbedded square tube. The size of this imbedded square tube is dictated by the size of the square shaft comprising the upper portion of the Worm Gear Assembly 8, which size is discussed immediately below. In the prototype, the square tube is imbedded in the very top portion of the Idler 6, is approximately 1″ long and approximately 3/16″ square.

The vertical shaft of the Worm Gear Assembly 8 has two distinct parts: the lower shaft, which is round with helix grooves cut into it, and the upper shaft, which is square. The vertical height of the helix grooves needs to be sufficient for the tines of the Stirring Disk 9 to start above the Filter Basket 11 and to reach near the bottom of the Filter Basket 11 during operation. In the prototype, the vertical height of the helix grooves is 1½″ in order to accommodate 1½″ tines for triple filter baskets. The lower shaft has smooth portions above and below the helix grooves to allow for the thickness of the Pawl Assembly 3 and the attachment of the flange to the bottom of the Worm Gear Assembly 8.

The upper shaft is square. To facilitate assembly, disassembly, cleaning and maintenance, the square shaft should slip through the Pawl Assembly 3 and therefore its cross sectional diagonal measurement must not exceed the diameter of the round lower shaft. In the prototype, the lower shaft diameter is approximately 3/16″ and the upper shaft is approximately 5/32″ square. The length of the upper shaft must be sufficient to allow it to remain above the Case Top 1a when the Pawl 3c is riding in the uppermost helix groove (and the Worm Gear Assembly 8 is at the lowest point of its vertical motion). In the prototype, the upper shaft was topped with a removal brass ball for decoration.

### 7. Other Models

The two drawings attached depict prototypes of the invention incorporating the worm gear. FIG. 1 shows the manual prototype in which the rotation of the Stirring Disk is caused by the motion of the barista's hand. FIG. 2 shows an electrical model in which a small motor causes the movement of the Stirring Disk. The electrical power could be supplied by house current or by batteries, perhaps even batteries that could be recharged in-situ.

More sophisticated electronics could be incorporated into the electrical model. For example, a start switch could activate the motor when the invention is placed over the filter basket. Even further, the motion of the Stirring Disk could be stopped automatically when it has returned to its starting position. Both of these features would be appreciated by the busy barista.

Another configuration would be mounting the invention on a countertop stand. Instead of placing the invention over the filter basket, the barista would simply hold or slide the portafilter into position under the invention. The stirring action could be initiated by a switch, or more sophisticated electronics could sense the presence of the portafilter and start the stop the stirring action automatically.

The invention could also be incorporated into or combined with other machines as described below.

The invention could be added onto a grinder. The machine would grind the beans, deposit a measured dose of ground coffee into the Basket, and then evenly distribute the grounds in the Basket employing the Stirring Disk.

The invention could be incorporated into a tamper. The machine would evenly distribute the grounds in the filter basket employing the Stirring Disk and then tamp them.

The invention could be incorporated into a machine that accomplished all four tasks: grinding, dosing, distributing and tamping.

Finally, the invention could be incorporated into espresso machines themselves.

1. The use of a disk with tines to stir espresso ground coffee in an espresso portafilter basket for the purpose of creating a more even distribution of said ground coffee to improve the taste of the resulting extraction of espresso coffee.

2. The simultaneous vertical and horizontal motion of the disk and tines referred to in claim Number One.

3. The use of a helix or worm gear to allow the disk with tines referred to in claim Number One to continue its horizontal motion, without stopping or reversing, as said disk with tines is moved both vertically and horizontally simultaneously as referred to in claim Number Two.
